(19) United States
(12) Patent Application Publication
(10) Pub. No.: US 2005/0196229 A1
(43) Pub. Date: Sep. 8, 2005

(54) Connecting shaft device and electronic device using the same

(75) Inventor: Ryuhei Nishida, Yokohama-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: NIFCO INC., Yokohama-shi (JP)

(21) Appl. No.: 11/070,253

(22) Filed: Mar. 3, 2005

(30) Foreign Application Priority Data
Mar. 5, 2004 (JP) 2004-062059

(51) Int. Cl. F16D 1/00

(52) U.S. Cl. 403/314

(57) ABSTRACT

A connecting shaft device connects one member having a first shaft hole, and another member having a second shaft hole having a large bore section, a small bore section, and an annular shoulder between the two sections. The connecting shaft device includes a female part having a tubular shape with two opening ends, and a male part having an abutment abutting against the annular shoulder of the second shaft hole and a leg shaft inserted into the female part. The female part has a flexible engagement piece at one tubular end thereof, so that the flexible engagement piece deforms upon inserting into the two shaft holes and restores an original shape to engage an opening of the first shaft hole where the tubular end projects from the opening of the first shaft hole.

### BACKGROUND OF THE INVENTION AND RELATED ART STATEMENT

The present invention relates to a connecting shaft device for rotationally connecting one member with a first shaft hole and another member with a second shaft hole, the shaft device being inserted into the one and another member in a condition that the first and second shaft holes are aligned, and an electronic device having a lid and a main body rotatably connected with the connecting shaft device.

Patent reference 1 discloses an engaging/fitting component having a flexible latching claw at one end thereof. With the engaging/fitting component, a first member having a first hinge tube is rotatably assembled with a second member having a second hinge tube. The engaging/fitting component is inserted into the first and second hinge tubes from the first hinge tube in a communicative state. The flexible latching claw engages an opening of the second hinge tube on an end side opposite to the communicative end.

In the engaging component, the first and second members are connected only with the flexible latching claw. When the engaging component is constructed so that the engaging component is easily inserted into the first and second hinge tubes, namely, the flexible latching claw is easily deformed, a coupling force of the engaging component relative to the two members is reduced. On the other hand, when the coupling force is increased, it is difficult to insert the engaging component.
Patent Reference 1; Japanese Patent Publication (Kokai) No. 2002-155927

In view of the problems described above, an object of the present invention is to provide a connecting shaft device in which one member with a first shaft hole and another member with a second shaft hole are rotatably assembled by inserting into the shaft holes communicating with each other. In the invention, it is easy to insert, while maintaining the coupling state of the two members.

Further objects and advantages of the invention will be apparent from the following description of the invention.

### SUMMARY OF THE INVENTION

In order to attain the objects described above, according to the present invention, a connecting shaft device connects one member having a first shaft hole and another member having a second shaft hole having a large bore section, a small bore section, and an annular shoulder between the two sections. In a state that the first shaft hole communicates with the small bore section of the second shaft hole, the one member is connected to the another member by inserting the connecting shaft device into the two shaft holes from the large bore section of the second shaft hole. The connecting shaft device comprises a female part having a tubular shape with two opening ends and a male part having an abutment abutting against the annular shoulder of the second shaft hole, and a leg shaft inserted into the female part.

The female part has a flexible engagement piece at one tubular end thereof, so that the flexible engagement piece deforms upon inserting into the two shaft holes and restores an original shape to engage an opening of the first shaft hole where the tubular end projects from the opening of the first shaft hole. While the female part is in the engaging state, a leg shaft of the male part is pushed into the female part to a fully pushed-in position, so that the flexible engagement piece of the female part does not deform inwardly.

In the invention, the flexible engagement piece of the female part engages the opening of the first shaft hole in the fully fitted position upon inserting the connecting shaft device into the shaft holes. While the female part is in the engaging state, the leg shaft of the male part is pushed into the female part to a fully pushed-in position, so that the flexible engagement piece of the female part does not deform inwardly. Even when the flexible engagement piece of the female part is constructed to facilitate flexible deformation when inserted into the two communicatively connected shaft holes, the male part is pushed into the female part, so that the engagement is firmly maintained. That is, the axial connection of the two members via the connecting shaft device is firmly maintained. With the connecting shaft device, it is possible to easily insert the connecting shaft device into the two shaft holes. After the leg shaft of the male part is completely pushed into the female part, it is possible to prevent the female part from coming out of the two shaft holes.

According to the present invention, the first shaft hole may be provided with a hole side groove or a hole side rib along an axis of the first shaft hole. The female part may be provided with a rib to be fitted into the hole side groove or a groove to be fitted into the hole side rib. The large bore section of the second shaft hole may be provided with a hole side groove or a hole side rib along an axis of the second shaft hole. The male part may be provided with a rib to be fitted into the hole side groove or a groove to be fitted into the hole side rib.

With the structure described above, the female part and one of the members can be integrated, and the male part and the other member can be integrated. In the case of making the second member immobile and rotating the first member, the first member can be rotated about the leg shaft of the male part. In the case of making the first member immobile and rotating the second member, the second member can be rotated by using an inner surface of the female part as a guide.

According to the present invention, the male part may include a main part with a head and a leg shaft, and a subpart having a tubular shape with two open ends for rotatably retaining the female part therein and an abutment on an outside thereof. The leg shaft of the main part has a circumferential groove for inserting a projection formed inside the female part, and a recess for inserting the projection between the circumferential groove and a tip of the leg shaft.

The projection is fitted into the circumferential groove over a section between the recess and the circumferential groove through flexible deformation when the main part is pushed from a temporarily fitted condition with the projection inserted into the recess to a fully pushed-in position. One of a head of the main part and the subpart has an elongated recess extending in the pushing direction of the main part, while the other has a projection fitted into the elongated recess.

With the structure described above, in the temporarily fitted condition, the main part and female part can be inseparably combined, so that the female part does not rotate about the leg shaft of the main part. The elongated recess and projection allow the subpart not to rotate relative to the main part coupled as described above with the outer surface of the female part as a guide. In the temporarily fitted condition, therefore, each part is kept immobile. When the connecting shaft device is inserted into the communicatively connected first shaft hole and second shaft hole in the temporarily fitted condition, the engagement section of the female part engages the opening of the first shaft hole, thereby temporarily coupling the two members. The parts do not move in the temporarily coupled condition, so that the two members coupled by the connecting shaft device are kept from rotating, thereby conveniently enabling other settings of the members.

Further, since none of the parts move in the temporarily fitted condition, it is easy to insert the connecting shaft device into the communicatively connected first and second shaft holes, while maintaining the orientation of the rib or groove of the female part so as to be consistent with the hole side groove or hole side rib formed in the first shaft hole and the orientation of the rib or groove of the male part so as to be consistent with the hole side groove or rib formed in the second shaft hole.

Further, by thrusting the main part constituting the male part to the fully pushed-in position from the temporarily fitted condition, the projection formed within the female part is fitted into the circumferential groove, thereby achieving the condition wherein the female part rotates about, or becomes rotatable relative to, the leg shaft of the main part constituting the male part (hereinafter referred to as the fully fitted condition) with a single motion.

According to the present invention, an electronic device has a lid and a main body. One of the lid or main body has a first shaft hole and the other of the two has a second shaft hole. The lid and main body are assembled by using the connecting shaft device described above.

In the electronic device constructed as above, the lid and main body can be temporarily combined easily, thereby positioning the lid and main body in the temporarily combined condition. In addition, in the fully fitted condition, the lid and main body are firmly rotatably coupled.

According to the present invention, it is easy to insert the connecting shaft device into the communicatively connected first shaft hole of the first member and second shaft hole of the second member, and the coupling of the two members is firmly maintained by the male part completely pushed into the female part.

### BRIEF DESCRIPTION OF PREFERRED EMBODIMENTS

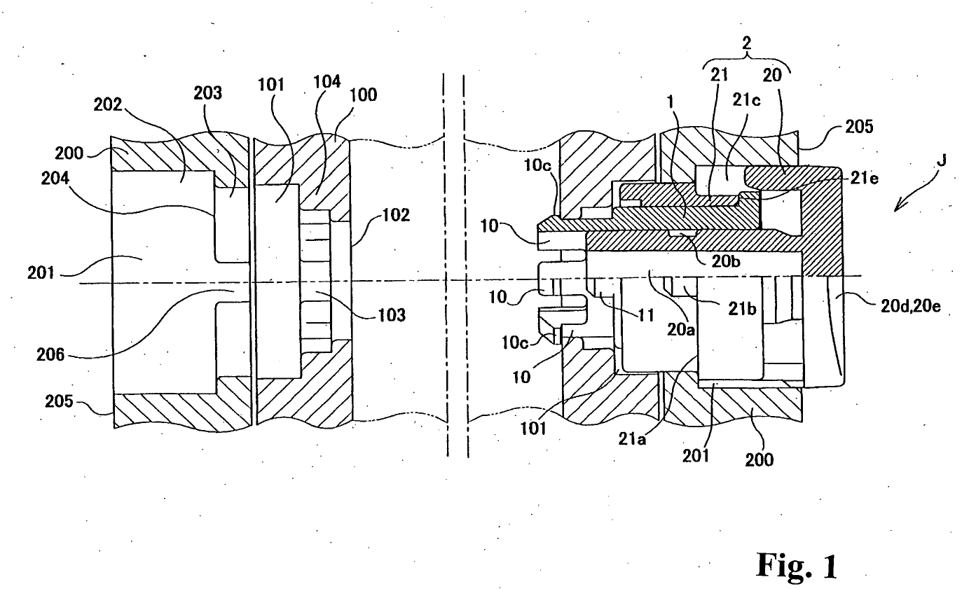

FIG. 1 is a sectional view showing a connecting shaft device in a use state according to an embodiment of the present invention;

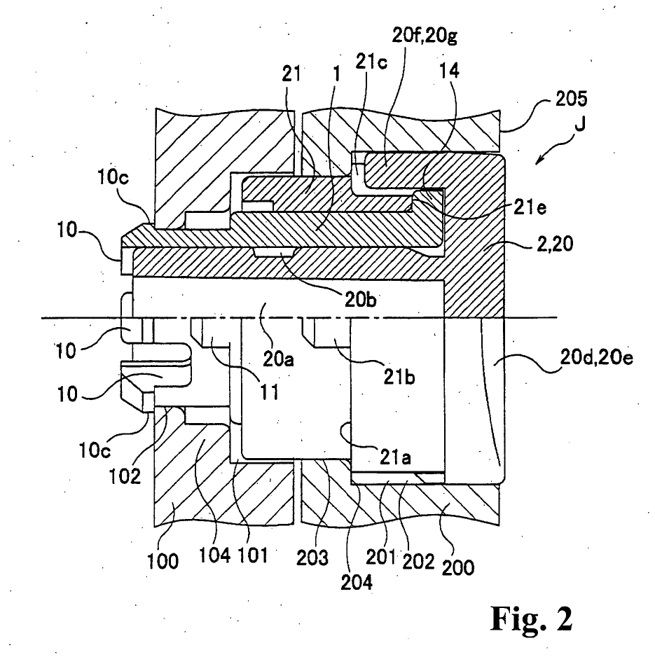

FIG. 2 is a sectional view showing the connecting shaft device in a use state;

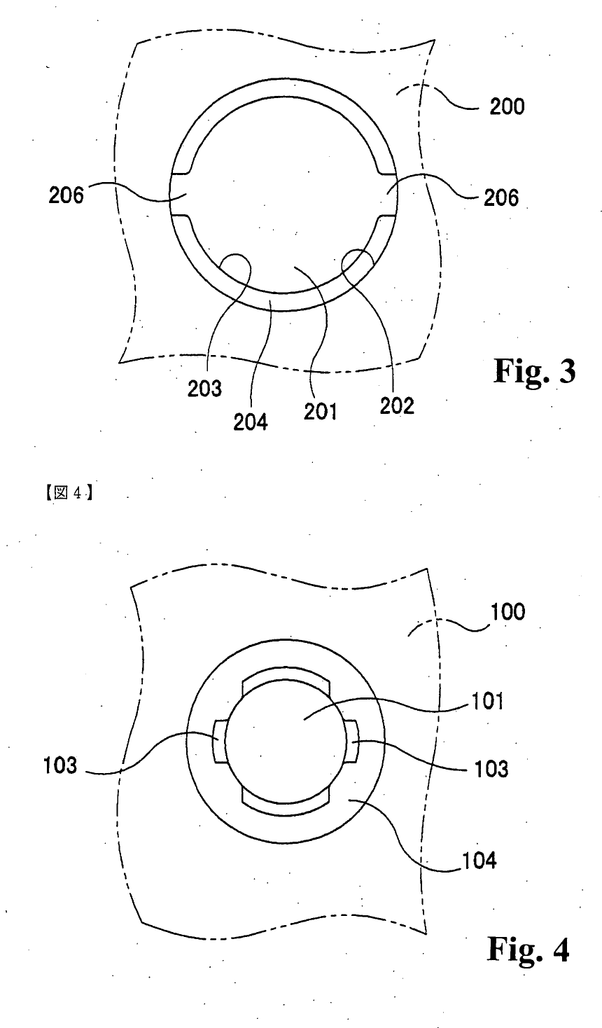

FIG. 3 is a side view of a second shaft hole formed in one member;

FIG. 4 is a side view of a first shaft hole formed in the other member;

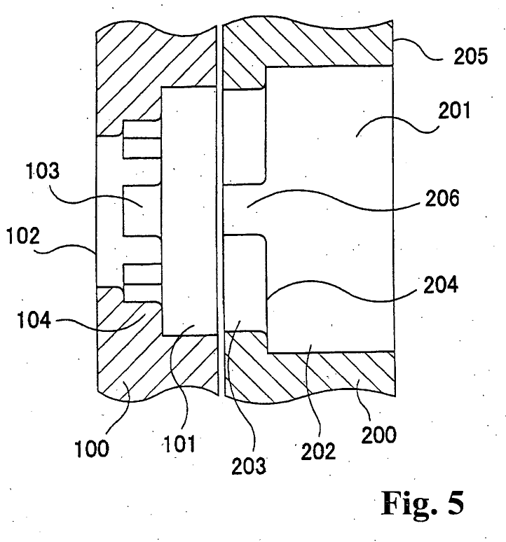

FIG. 5 is a sectional view of the first shaft hole formed in the one member and the second shaft hole formed in the other member;

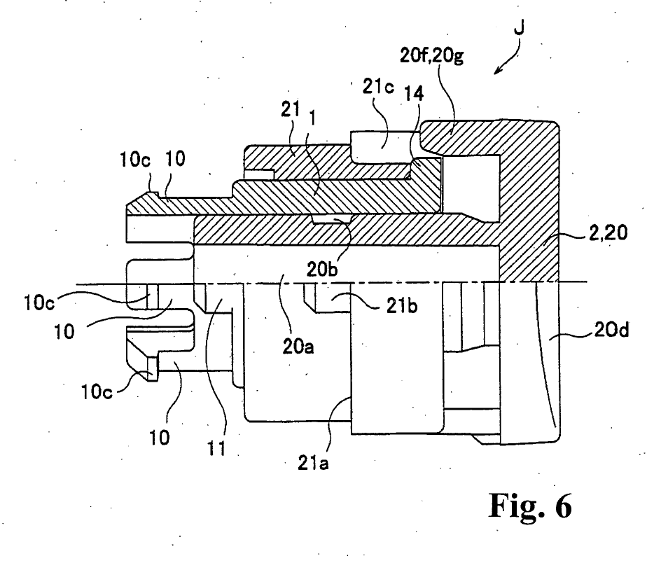

FIG. 6 is a sectional front view of the connecting shaft device;

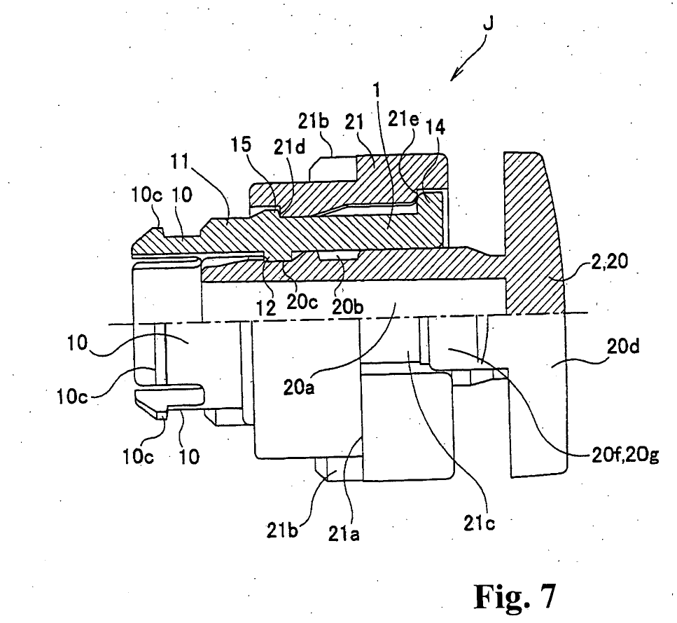

FIG. 7 is a sectional plan view of the same;

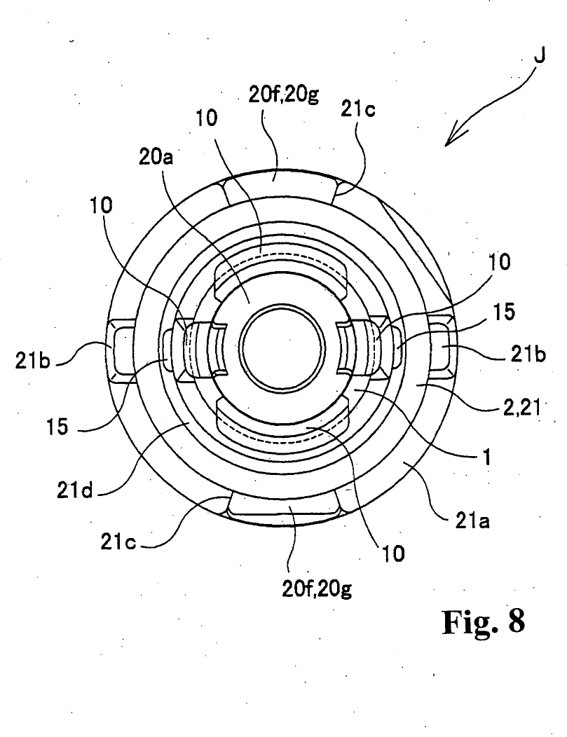

FIG. 8 is a left side view of the same;

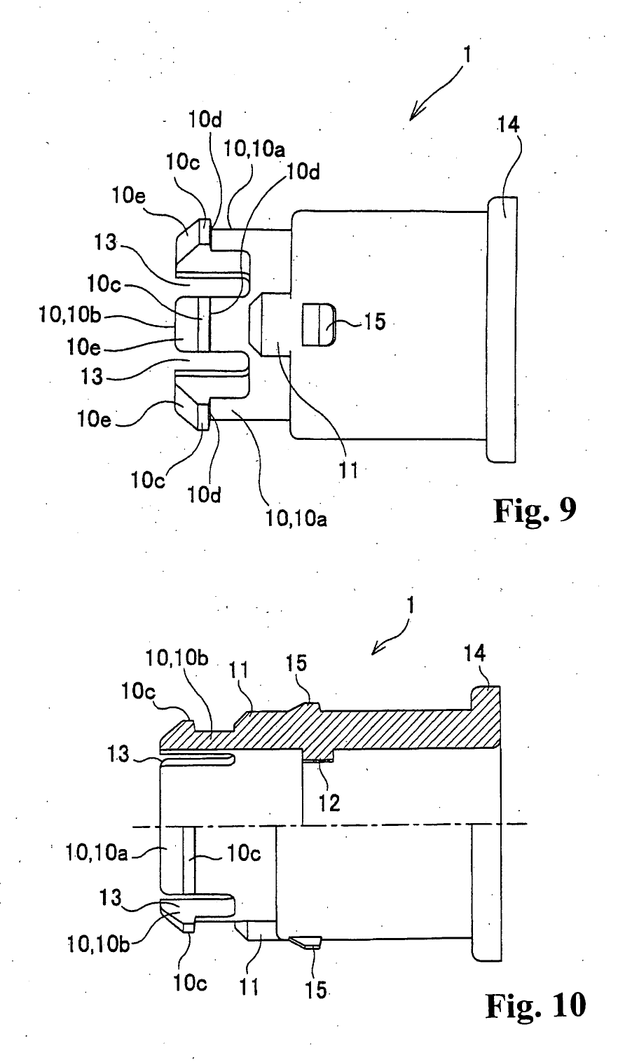

FIG. 9 is a front view of a female part;

FIG. 10 is a sectional bottom plan view of the same;

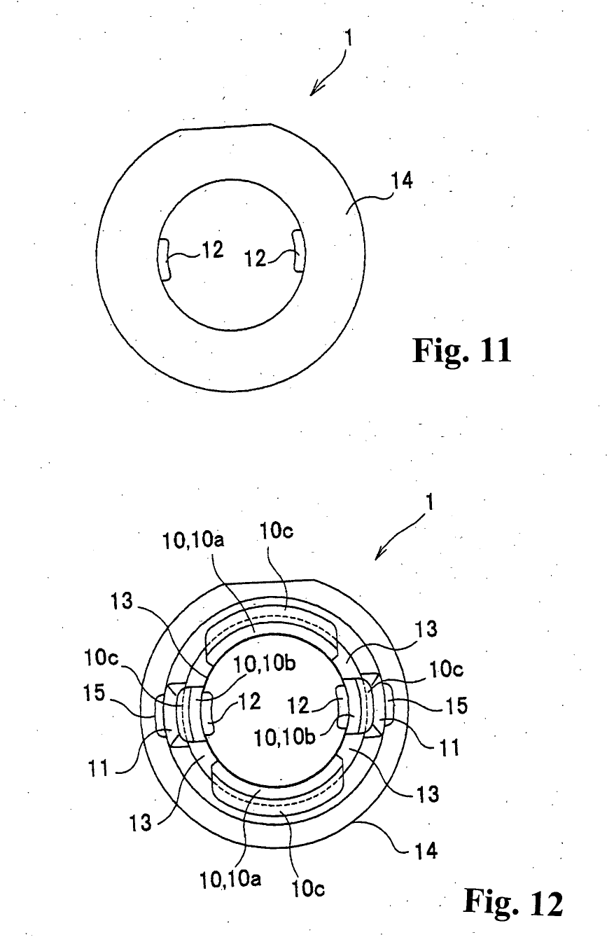

FIG. 11 is a right side view of the same;

FIG. 12 is a left side view of the same;

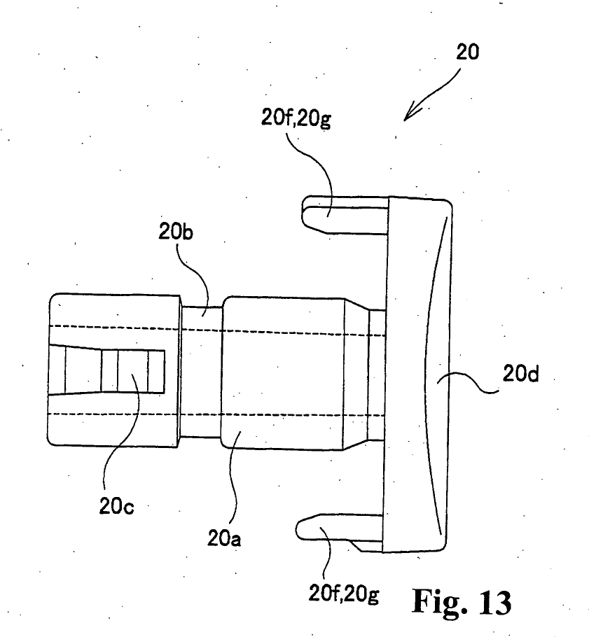

FIG. 13 is a front view of a main part;

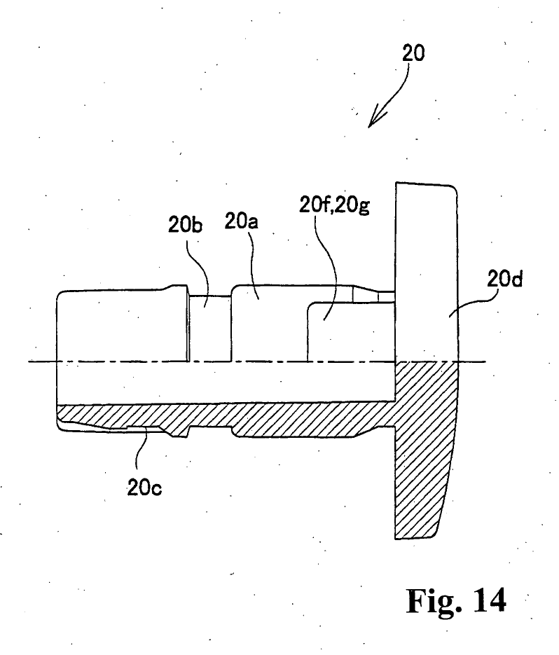

FIG. 14 is a sectional plan view of the same;

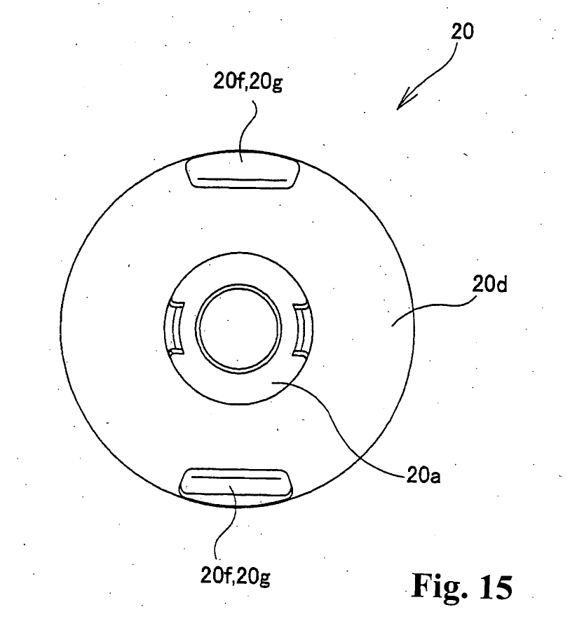

FIG. 15 is a left side view of the same;

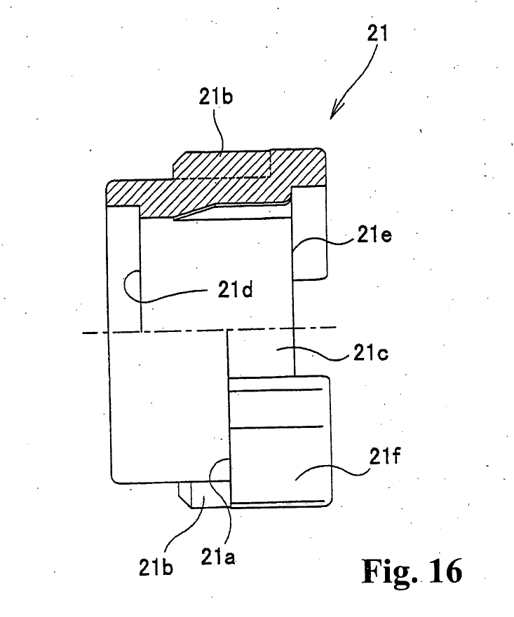

FIG. 16 is a front view of a sub part;

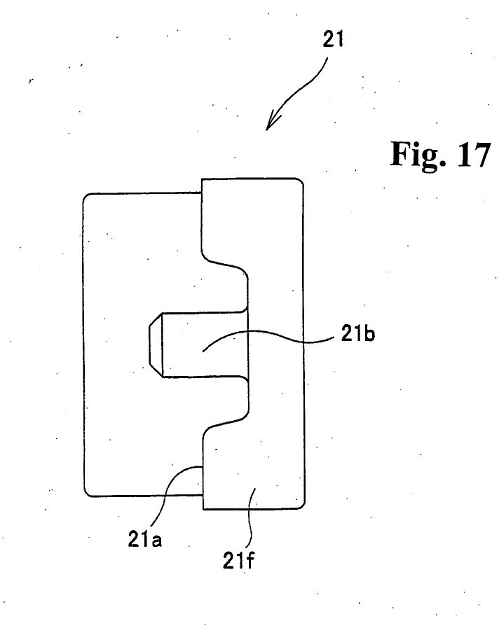

FIG. 17 is a plan view of the same;

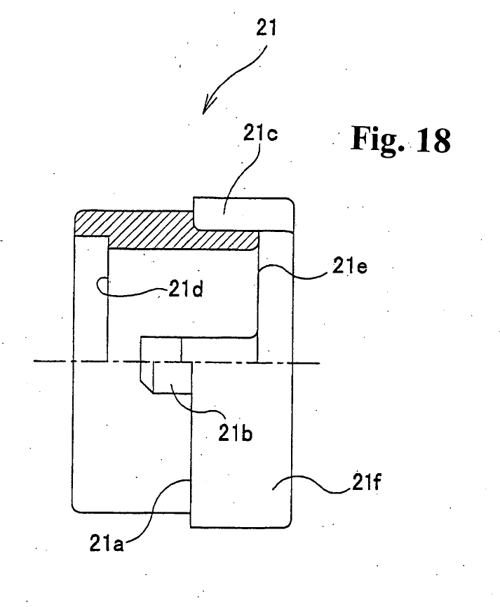

FIG. 18 is a sectional bottom view of the same;

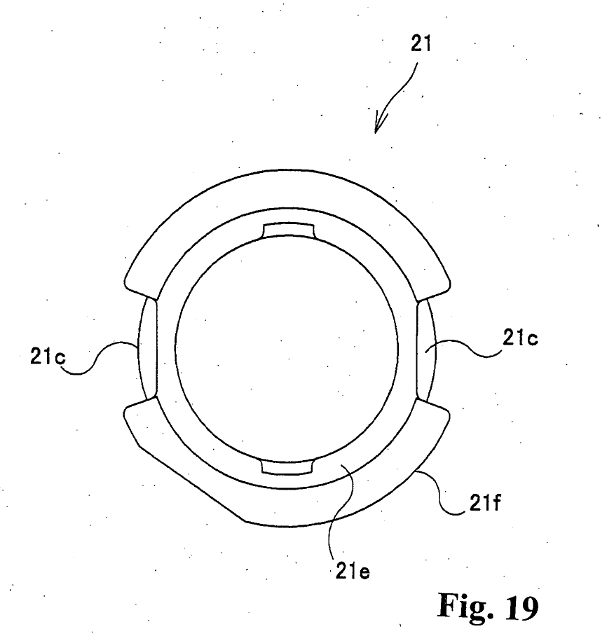

FIG. 19 is a right side view of the same; and

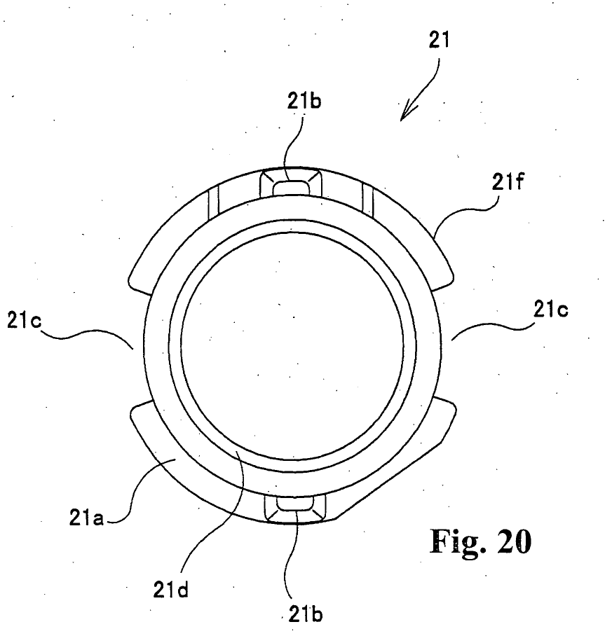

FIG. 20 is a left side view of the same.

### DETAILED DESCRIPTION OF PREFERRED EMBODIMENTS

Hereunder, embodiments of the present invention will be explained with reference to the accompanying drawings. FIG. 1 illustrates the following condition: one member 100 having a first shaft hole 101 in two locations is combined with another member 200 having a second shaft hole 201 in two locations. A connecting shaft device J is temporarily fitted into the first shaft hole 101 and second shaft hole 201 disposed on one side and communicatively connected with each other. FIG. 2 illustrates the connecting shaft device J in a fully fitted state. FIGS. 3 and 4 show the second shaft hole 201 and the first shaft hole 101, respectively, and FIG. 5 shows the condition wherein the two shaft holes 101 and 201 are communicatively connected. (FIGS. 3 and 4 show the shaft hole 101 and shaft hole 201 individually viewed from the right side in FIG. 5.) FIGS. 6 to 8 show the connecting shaft device J in a temporarily fitted state. FIGS. 9 to 12 show the female part 1, and FIGS. 13 to 20 show the main part 20 and the subpart 21 constituting the male part 2.

In the embodiment, the connecting shaft device J rotatably couples the member 100 having the first shaft hole 101 with the member 200 having the second shaft hole 201 when the connecting shaft device J is fitted into both shaft holes 101 and 201 that are communicatively connected. In other words, the connecting shaft device J comprises a hinge component for various types of articles.

An electronic device related to the embodiment is provided with a lid and a main body rotatably connected with the connecting shaft device J. Such an electronic device includes a portable telephone, notebook PCs and the like, more specifically, a portable telephone wherein a lid (a member including a liquid crystal display section) is rotatably coupled with a body (a member including an operating section including push buttons) by using the connecting shaft device J described above, and a notebook PC wherein a lid (a member including a liquid crystal display section) is rotatably coupled with a body (a member including a keyboard) by using the connecting shaft device J described above.

The connecting shaft device J couples one member 100 having a first shaft hole 101 with another member 200 having a second shaft hole 201 comprising a large bore section 202, a small bore section 201, and an annular shoulder 204 formed between the two sections 202 and 203 when the connecting shaft device J is fitted into both shaft holes 101 and 201 from the large bore section 202 in the condition wherein the small bore section 203 of the second shaft hole 201 is communicatively connected with the first shaft hole 101.

The connecting shaft device J comprises a female part 1 and a male part 2. The female part 1 has a tubular shape with two free ends. The male part 2 has an abutment 21a abutting against the annular shoulder 204 and a leg shaft 20a fitted within the female part 1.

At one tubular end of the female part 1, a flexible engagement piece 10 is formed, which flexibly deforms inwardly when the connecting shaft device J is fitted into the communicatively connected shaft holes 101 and 201, and regains an original shape for engaging the engagement sections 10c with the opening 102 of the first shaft hole 101 at the fully fitted position wherein the tubular end protrudes from the opening of the first shaft hole 101.

In the engagement state of the female part 1, the flexible inward deformation of the flexible engagement piece 10 of the female part 1 is blocked by the leg shaft 20a of the male part 2 pushed into the female part 1 to a fully pushed-in position. When the engagement sections 10c engages the opening 102 of the first shaft hole 101 in the fully fitted position within the communicatively connected shaft holes 101 and 201, the female part 1 is stably held by pushing the leg shaft 20a of the male part 2 into the female part 1 to prevent the flexible inward deformation of the flexible engagement piece 10 with the engagement sections 10c.

Even if the engagement piece 10 of the female part 1 is so constructed as to easily flexibly deform when the connecting shaft device J is fitted in the communicatively connected shaft holes 101 and 201, the insertion of the male part 2 firmly maintains the engagement of the female part 1, namely, the shaft connection between the members 100 and 200 via the connecting shaft device J. In other words, the connecting shaft device J facilitates the insertion of the female part 1 into the shaft holes 101 and 201, and, at the same time, securely prevents the female part 1 from coming out of the shaft holes 101 and 201 when the leg shaft 20a of the male part 2 is completely pushed into the female part 1.

In the embodiment, the first shaft hole 101 is provided therein with hole side grooves or hole side ribs formed along the axis of the first shaft hole 101. The female part 1 is provided with ribs to be fitted into the hole side grooves or grooves to be fitted into the hole side ribs as it is inserted into the first shaft hole 101. The large bore section 202 of the second shaft hole 201 is provided therein with hole side grooves or hole side ribs formed along the axis of the second shaft hole 201. The male part 2 is provided with ribs to be fitted into the hole side grooves or grooves to be fitted into the hole side ribs as it is inserted into the second shaft hole 201.

Therefore, the female part 1 and the member 100 are integrated, and the male part 2 and the other member 200 are integrated. In the case of rotating the member 100 while holding the other member 200 steady, the member 100 can be rotated about the leg shaft 20a of the male part 2. Similarly, in the case of rotating the member 200 while holding the other member 100 steady, the member 200 can be rotated by using the inner surface of the female part 1 as a guide.

As described later, in the case wherein the male part 2 has a head 20d having an outer head surface 20e which constitutes one section of the outer surface of the member 200, the grooves or ribs cause a directional insertion of the male part 2 into the second shaft hole 201 of the member 200. Thus, such an insertion of the male part 2 into the second shaft hole 201 has a feature of providing a well-matched design between the outer head surface 20e of the male part 2 and the outer surface 205 of the member 200.

In the embodiment, the first shaft hole 101 is provided therein with hole side grooves 103 formed along the axis of the first shaft hole 101. The female part 1 is provided with ribs 11 to be fitted into the hole side grooves 103 as it is inserted into the first shaft hole 101. The large bore section 202 of the second shaft hole 201 is provided therein with hole side grooves 206 along the axis of the second shaft hole 201. The male part 2 is provided with ribs 21b to be fitted into the hole side grooves 206 as it is inserted into the second shaft hole 201.

In the embodiment, the male part 2 is formed of a main part 20 having a head 20d and a leg shaft 20a, and a subpart 21 having a tubular shape with two free ends and rotatably retaining the female part 1 therein, and includes an abutment 21a formed externally. The leg shaft 20a of the main part 20 is provided with a circumferential groove 20b into which the projections 12 formed within the female part 1 are fitted, and a recess 20c into which the projections 12 are fitted at a location between the circumferential groove 20b and the tip of the leg shaft 20a.

From the temporarily fitted condition wherein the projections 12 are fitted into the recess 20c, the main part 20 is pushed to the fully pushed-in position, as the projections 12 pass over the section between the recess 20c and the circumferential groove 20b, through flexible deformation to be fitted into the circumferential groove 20b. One of the head 20d of the main part 20 or the subpart 21 is provided with elongated recesses 21c, which extend along the thrusting direction of the main part 20, and the other of the two is provided with protruded parts 20f that are fitted into the elongated recesses 21c.

According to the connecting shaft device J in the embodiment, first of all, in the temporarily fitted condition, the main part 20 and the female part 1 are inseparably combined, so that the female part 1 does not rotate about the leg shaft 20a of the main part 20. The elongated recesses 21c and protruded parts 20f function for the main part 20 coupled as described above to prevent the subpart 21 from rotating by using the outer surface of the female part 1 as a guide. In the temporarily fitted condition, therefore, each part is kept immobile. When the connecting shaft device J is inserted into the communicatively connected first shaft hole 101 and second shaft hole 201 in the temporarily fitted condition, the engagement sections 10c of the female part 1 engages the opening 102 of the first shaft hole 101, thereby temporarily coupling the member 100 and the other member 200.

Since none of the parts move in the temporarily coupled condition, the members 100 and 200 are kept from rotating as they are coupled by the connecting shaft device J, thereby enabling other settings for the members 100 and 200. For example, in achieving the coupling in the article (FIG. 1) wherein the first shaft hole 101 and the second shaft hole 201 are disposed on both the right and left sides, and members 100 and 200 are rotatably coupled by fitting the connecting shaft device J into the first shaft hole 101 and the second shaft hole 201 disposed on both the right and left sides, since the members 100 and 200 are coupled not to rotate in the state wherein the connecting shaft device J is temporarily fitted into the first shaft hole 101 and the second shaft hole 201 disposed on the right side, the connecting shaft device J can be conveniently fitted into the first shaft hole 101 and the second shaft hole 201 disposed on the left side in this state (FIG. 1).

Secondly, since none of the parts described move in the temporarily fitted condition, it is easy to insert the connecting shaft device J into the communicatively connected first and second shaft holes 101 and 201, while maintaining the orientation of the ribs or grooves of the female part 1 so as to be consistent with the hole side grooves or hole side ribs formed in the first shaft hole 101, and the orientation of the ribs or grooves of the male part 2 so as to be consistent with the hole side grooves or ribs formed in the second shaft hole 201.

Thirdly, by thrusting the main part 20 constituting the male part 2 to the fully pushed-in position from the temporarily fitted condition, the projections 12 formed within the female part 1 are fitted into the circumferential groove 20b, thereby obtaining the state wherein the female part 1 rotates about, or becomes rotatable relative to, the leg shaft 20a of the main part 20 constituting the male part 2 (hereinafter referred to as the fully fitted condition) with a single motion. In the fully fitted condition, the members 100 and 200 are rotatably coupled (see FIG. 2).

(Female Part 1)

In the embodiment, the female part 1 has a tubular shape with two open ends. The flexible engagement piece 10 is formed on one tubular end of the female part 1. A pair of narrow flexible engagement pieces 10b is formed in one portion of the female part 1 defined by a pair of gaps 13 extending along the axis of the female part 1 on one open end of the female part 1. A wide flexible engagement piece 10a is formed between the pair of narrow flexible engagement pieces 10b. Each of the flexible engagement pieces 10b and 10a is provided with the engagement section 10c formed on the outer face at the tip. The engagement section 10c is formed as a projection having an engagement face 10d facing the other end of the tubular female part 1. The side facing the tip of the flexible engagement piece 10 is a sloping surface 10e gradually increasing in height toward the upper end. The sloping surface 10e allows the flexible engagement piece 10 to smoothly deform when the female part 1 is inserted into the first shaft hole 101.

In the embodiment, moreover, the first shaft hole 101 of the member 100 is so formed that the opening 102, which is caught by the flexible engagement sections 10c, is narrower than the opposing opening by using a ring-shaped rise 104, and the distance between the top ends of the pair of flexible engagement sections 10c of the female part 1 is slightly larger than the bore of the first shaft hole 101 at a location of the ring-shaped rise 104.

The ribs 11 are formed on the outer face of the female part 1, so that one end of the ribs is located at the bases of the narrow flexible engagement pieces 10b and extends along the axis of the female part 1. The ribs 11 are inserted into the hole side grooves 103 formed in the first shaft hole 101 when the female part 1 is inserted into the first shaft hole 101, thereby integrating the female part 1 and the member 100. The hole side grooves 13 are formed of cut-away sections formed by cutting away the ring-shaped rise 104 and leaving a space between the grooves and the edge of the opening 102 of the first shaft hole 101, which is caught by the engagement sections 10c.

In the embodiment, a circumferential flange 14 is formed at the other end of the tubular female part 1 so as to overhang outwardly. In addition, small projections 15 are formed at the other end of the ribs 11 facing the end of the tubular female part 1. A first annular shoulder 21d is formed in the subpart 21 constituting the male part 2 toward one tubular end so as to face the tubular end, and a second annular shoulder 21e is formed in the subpart 21 toward the other tubular end so as to face the tubular end. The female part 1 is inserted from the latter tubular end to the position wherein the circumferential flange 14 is flush with the second annular shoulder 21e. In this step, the female part allows the small projections 15 to pass over the rise that creates the first annular shoulder 21d through flexible deformation, and allows the small projections 15 to catch the first annular shoulder 21d in the fully fitted position. The projections 12 are formed in the female part 1 at the positions where the small projections 15 are formed in the female part 1.

(Male Part 2/Main Part 20)

In the embodiment, the main part 20 constituting the male part 2 includes a tubular-shaped leg shaft 20a and a disc-shaped head 20d. One shaft end of the leg shaft 20a is integrally joined with the head 20d in the center of one surface thereof. The circumferential groove 20b is formed around the axis of the leg shaft 20a on the outer face of the leg shaft 20a, and the recess 20c is formed between the other shaft end of the leg shaft 20a and the circumferential groove 20b.

The head 20d is provided with diametrically disposed plates 20g; one end of each is integrally connected with the edge on one surface of the head 20d and extends in the thrusting direction of the leg shaft 20a. The plates 20g function as the protruded parts 20f.

(Male Part 2/Subpart 21)

In the embodiment, the subpart 21 constituting the female part 2 has a tubular shape with two open ends, and the first annular shoulder 21d and second annular shoulder 21e therein. A circumferential rise 21f is formed on the outer surface of the subpart 21 toward the other end. The circumferential rise 21f forms the abutment 21a that abuts against the annular shoulder 204 formed within the second shaft hole 201.

The ribs 21b are formed so that one end of each rib is connected with the circumferential rise 21f and extends along the axis of the subpart 21. The ribs 21b are inserted into the hole side grooves 206 formed in the second shaft hole 201 as the male part 2 is inserted into the second shaft hole 201, thereby integrating the male part 2 and the member 200. The hole side grooves 206 are formed at the narrow bore section 203 of the second shaft hole 201. Groove ends of the hole side grooves 206 are free both at the annular shoulder 204 of the second shaft hole 201 and the opening of the narrow bore section 203, which is the side communicatively connected with the first shaft hole 101. The hole side grooves are formed so as to position the groove bottoms on the same plane as that of the inner hole surface of the large bore section 202 of the second shaft hole 201.

In the embodiment, the circumferential rise 21f of the subpart 21 is diametrically divided by the elongated recesses 21c of the subpart 21. The plates 20g serving as the protruded parts 20f of the main part 20 are fitted into the elongated recesses 21c in the condition wherein the leg shaft 20a of the main part 20 is temporarily fitted into the female part 1. The width of the elongated recesses 21c is substantially equal to the width of the plates 20g that serve as the protruded parts 20f, so that the main part 20 and the subpart 21 are integrated without rattling in the rotational direction when the protruded parts 20f are fitted into the elongated recesses 21c. In the temporarily fitted condition, the elongated recesses 21c have a sufficient length between the tip of the plates 20g, which serve as the protruded parts 20f, and the terminating end of the elongated recesses 21c, so that the main part 20 is pushed into the fully fitted position. The elongated recesses 21c allow the main part 20 to move from the position where the tips of the plates 20g serving as the protruded parts 20f are inserted at the starting ends to the position where the tips of the plates 20g come near their terminating ends (namely, the fully pushed-in position).

After the female part 1 is completely inserted into the subpart 21 as described above, the leg shaft 20a is inserted into the female part 1 until it reaches the position where the projections 12 of the female part 1 are fitted into the recess 20c. Accordingly, the protruded parts 20f are fitted into the elongated recesses 21c, the main part 20 is integrated with the subpart 21. The male part 2 having the main part 20 and subpart 21 and the female part 1 are combined in the temporarily fitted condition.

In the temporarily fitted condition, the connecting shaft device J is inserted into the communicatively connected first shaft hole 101 and second shaft hole 201 until it reaches the position where the abutment 21a of the subpart 21 abuts against the annular shoulder 204 of the second shaft hole, thereby engaging the engagement sections 10c of the female part 1 with the opening 102 of the first shaft hole 101 to temporarily combine the members 100 and 200.

By pushing the main part 20 constituting the male part 2 from the temporarily coupled position to the fully pushed-in position, the inward flexible deformation of the flexible engagement piece 10 of the female part 1 is prevented. The projections 12 of the female part 1 are fitted into the circumferential groove 20b formed in the leg shaft 20a of the male part 2, thereby enabling the female part 1 to rotate, or become rotatable, relative to the outer surface of the main part 20 and the inner surface of the subpart 21 constituting the male part 2.

Each part may be molded with a plastic to impart flexible property necessary for flexible deformation. The use of plastic effectively reduces frictional resistance at the location where the female part 1 contacts the male part 2, and allows the female part 1 to smoothly rotate.

According to the present invention, an electronic device has a lid and a main body. The first shaft hole 101 may be formed in the lid or main body, and the second shaft hole 201 may be formed in the other. The lid and main body are connected with the connecting shaft device J explained above for temporarily coupling the lid and main body. In the temporarily assembled condition, the lid and main body can be positioned, and in the fully fitted condition, the lid and main body are firmly rotatably coupled.

The disclosure of Japanese Patent Application No. 2004-062059, filed on Mar. 5, 2004, is incorporated in the application.

While the invention has been explained with reference to the specific embodiments of the invention, the explanation is illustrative and the invention is limited only by the appended claims.

1. A connecting shaft device for connecting a first member having a first shaft hole, and a second member having a second shaft hole, comprising:
a female part having a tubular shape with two open ends, and including a flexible engagement piece at one of the open ends for flexibly deforming when the female part is inserted into the first and second shaft holes, said flexible engagement piece restoring an original shape thereof when the female part is fully fitted into the first and second shaft holes and engaging an edge of the first shaft hole, and
a male part having an abutment abutting against a shoulder of the second shaft hole, and a leg shaft for inserting into the female part, said leg shaft being pushed into the female part when the female part engages the first shaft hole so that the flexible engagement piece does not deform inwardly.

2. A connecting shaft device according to claim 1, wherein said female part further includes a first rib or a first groove so that the first rib is fitted into a first hole side groove of the first shaft hole or the first groove is fitted into a first hole side rib of the first shaft hole, and said male part further includes a second rib or a second groove so that the second rib is fitted into a second hole side groove of the second shaft hole or the second groove is fitted into a second hole side rib of the second shaft hole.

3. A connecting shaft device according to claim 1, wherein said male part includes a main part having a head and a Leg shaft extending from the head to be located inside the female part, and a subpart with a tubular shape for rotatably retaining the female part therein, said subpart having an abutment on an outer surface thereof.

4. A connecting shaft device according to claim 3, wherein said female part further includes a projection formed on an inner surface thereof, and said leg shaft has a circumferential groove for fitting the projection of the female part in a temporarily fitted state and a recess between the circumferential groove and a tip of the leg shaft for fitting the projection so that the projection moves from the circumferential groove to the recess and is fitted into the recess when the main part is pushed into a fully pushed-in position.

5. A connecting shaft device according to claim 4, wherein one of said head and said subpart has an elongated recess extending in a direction that the main part is pushed in, and the other of said head and said subpart has a projecting portion fitted into the elongated recess.

6. An electronic device comprising the connecting shaft device according to claim 1, a lid, and a main body connected to the lid with the connecting shaft device.
